(19) United States
(12) Patent Application Publication
(10) Pub. No.: US 2022/0404994 A1
(43) Pub. Date: Dec. 22, 2022

(54) DIRECT ACCESS (DAX) FILE ACCESS RESPONSIVE TO INTERCEPTION OF FILE ACCESS FUNCTION CALL

(71) Applicant: HEWLETT-PACKARD DEVELOPMENT COMPANY, L.P., Spring, TX (US)

(72) Inventors: Jose Dirceu Grundler Ramos, Porto Alegre (BR); Shane Ward, Fort Collins, CO (US); Craig Lucero, Fort Collins, CO (US); Raphael Gay, Fort Collins, CO (US)

(73) Assignee: HEWLETT-PACKARD DEVELOPMENT COMPANY, L.P., Spring, TX (US)

(21) Appl. No.: 17/779,223

(22) PCT Filed: Nov. 27, 2019
(86) PCT No.: PCT/US2019/063647

§ 371 Date: May 24, 2022

(51) Int. Cl. G06F 3/06

(52) U.S. Cl. CPC G06F 3/0643; G06F 3/0656; G06F 3/0611; G06F 3/0673

(57) ABSTRACT

A call with respect to data for a file from an application program running on a computing device to a block-oriented file access function of an operating system running on the computing device is intercepted. A DAX file access is responsively performed with respect to a memory region of a persistent memory storing the file and an application buffer for the application program within an application memory space to which the memory region has been mapped.

### BACKGROUND

Data within computing systems has historically been organized between two tiers: faster but smaller-capacity memory and larger-capacity but slower storage. Memory, such as dynamic random-access memory (DRAM), has traditionally been volatile, and is directly addressable at the byte level. Storage, including hard disk drives and more recently solid-state drives, by comparison is accessible in a block-oriented manner. As a general rule, data has usually been stored in storage on a long-term basis, and temporarily moved to memory for short-term access or transformation prior to being moved back to storage when finished.

### BRIEF DESCRIPTION OF THE DRAWINGS

FIG. 1 is a diagram of an example architecture to provide for direct access (DAX) file access via interception of legacy file access function calls.

FIG. 2 is a flowchart of an example method for opening or creating a file in persistent memory for subsequent DAX file access.

FIG. 3 is a flowchart of an example method for accessing data of a file in persistent memory in a DAX manner.

FIG. 4 is a flowchart of an example method for specifically reading data from a file in persistent memory in a DAX manner.

FIG. 5 is a flowchart of an example method for specifically writing data to a file in persistent memory in a DAX manner.

FIG. 6 is a flowchart of an example method for closing a file in persistent memory.

FIG. 7 is a diagram of an example computer-readable data storage medium.

FIG. 8 is a diagram of an example compute device.

### DETAILED DESCRIPTION

As noted in the background, computing systems have typically organized data between two tiers: faster, smaller-capacity memory for short-term access, and slower, larger-capacity storage for long-term storage. More recently, however, non-volatile memory like non-volatile dual-inline memory modules (NVDIMMs) has been introduced that provide for a third tier of memory: persistent memory. Persistent memory can be byte-addressable like traditional (volatile) memory, but also non-volatile like traditional storage.

Persistent memory permits data files to be accessed at the byte level using memory-like load and store operations, instead of having to be accessed using a block-oriented approach in which blocks of data are retrieved from storage and temporarily cached in memory. Therefore, data files can be more quickly accessed, akin to memory, from where they are stored on persistent memory. Such so-called direct access (DAX) amounts to a paradigm shift in how data is stored and accessed within computing systems.

However, existing applications that access files using a block-oriented approach cannot automatically take advantage of the faster throughput that persistent memory offers, even if the underlying operating system provides this capability. For example, block-oriented file access generally entails calling suitable operating system functions exposed by application programming interfaces (APIs) to open and then read and write the files before closing them. To read data from an opened file, for instance, an application calls a corresponding function of an operating system, which may retrieve a block of data including the requested data from storage, and then pass the requested data back to the application. The blocks of data are commonly 512 bytes or four kilobytes in size.

By comparison, byte-level file access can involve calling a memory mapping function of the operating system via a corresponding API after having opened a file to create a memory map between the persistent memory region that stores the file and a memory space for the application within volatile memory. Once this memory map has been created, the application can directly access the file via DAX, using associated memory-like load and store instructions (i.e., operations). Such load and store instructions commonly retrieve eight bytes of memory at a time, particularly in the context of x86-compatible processors. Applications that currently use a block-oriented approach to access files thus have to be rewritten to at least some degree to instead use the faster byte-level file access afforded by persistent memory.

Techniques described herein, by comparison, permit application programs to use DAX without having to be updated to directly take advantage of persistent memory. Calls made by application programs to legacy file access functions of operating systems, which may not use DAX and thus which may be considered non-DAX file access functions, are intercepted, and DAX file access is instead responsively performed, such as via direct load and store operations. The applications therefore ostensibly continue using legacy, block-oriented file access functions to access file data. However, via interception of calls to these legacy functions, the requested file data access can instead be realized via direct byte-level load and store instructions using the memory mappings between persistent memory and application memory space.

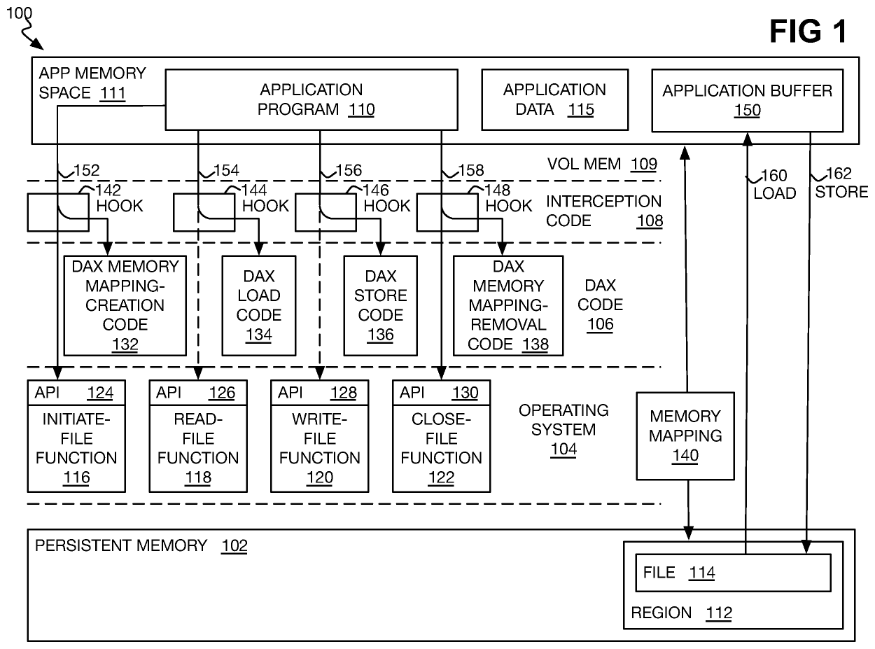

FIG. 1 shows an example architecture, or model, 100 that provides for direct access (DAX) file access via interception of calls to legacy file access functions, which may not use DAX and thus which may be considered non-DAX file access functions. The architecture 100 includes persistent memory 102, which can include NVDIMMs or another type of persistent memory. The architecture 100 further includes an operating system 104 that supports DAX file access of the persistent memory 102. For example, the operating system 104 may be a version of the MICROSOFT WINDOWS or the LINUX operating system, each of which in more recent versions provides such DAX file access via memory-mapped files.

The architecture 100 includes DAX code 106 and interception code 108, which together form program code that permits legacy applications to use DAX to access files stored within the persistent memory 102 without having to be updated (e.g., rewritten) to use the memory-mapped file capability of the operating system 104. In the example of FIG. 1, the architecture 100 includes such an application program 110. The application program 110 can also be referred to as an application, and is the program code that is executable to perform the functionality of the program 110.

The application program 110 resides within an application memory space 111 that is allocated to the program 110 within volatile memory 109, such as dynamic random-access memory (DRAM), when the application program 110 is executed. Execution of the application program 110 loads the program 110 into this allocated memory space 111, which also can include application data 115 on which the program 110 is operative while running. The application memory space 111 also includes an application buffer 150 for the application program 110, in relation to which DAX file access can occur via load and store instructions or operations. The application buffer 150 is separate from the application data 115, but in other implementations may be considered as part of the application data 115.

The application program 110 accesses files stored on the persistent memory 102 by calling legacy block-oriented functions of the operating system 104. However, the DAX code 106 and the interception code 108 together achieve file access via DAX instead, such as by using direct byte-level load and store instructions. A legacy block-oriented file function may be a block-oriented file function in that it performs functionality at the block level (e.g., with respect to blocks that may commonly be 512 bytes or four kilobytes in size) instead of at the byte level (e.g., commonly with respect to lines of memory that are eight bytes in length). A legacy block-oriented file function may be a legacy file function in that it may have been developed to access files stored on storage like hard disk drives and solid-state drives, instead of storage like persistent memory that is accessible at the byte level. If the legacy block-oriented file function does not use DAX to perform its functionality (i.e., in a non-DAX manner), then it can be considered a non-DAX file access function.

The operating system 104 may specifically include an initiate-file function 116, a read-file function 118, a write-file function 120, and a close-file function 122. The initiate-file function 116 is called to open an existing file or to create a new file. For example, in the MICROSOFT WINDOWS operating system, there is a CreateFile( ) function that can be used to open an existing file or create a new file. In the LINUX operating system, there is an open( ) function that is used to open an existing file or create a new file. The initiate-file function 116 may have to be called regardless of whether a file is to be accessed in a legacy block-oriented manner or in a direct byte-level DAX manner.

The read-file and write-file functions 118 and 120 are more generally file-access functions that are called to access (i.e., read or write) a file after the file has been opened or created via the initiate-file function 116. The functions 118 and 120 are legacy block-oriented functions. In the MICROSOFT WINDOWS operating system, the read-file and write-file functions 118 and 120 are ReadFile( ) and WriteFile( ) respectively. By comparison, in the LINUX operating system, the read-file and write-file functions 118 and 120 are read( ) and write( ) respectively.

When a call is made to the read-file function 118, the operating system 104 may read a file data block including the requested data, temporarily store the block in volatile memory, and return the requested data to the calling application. When a call is made to the write-file function 120, the operating system 104 may write a block including data passed by the calling application after first temporarily storing the data in memory. The read-file and write-file functions 118 and 120 are thus operative at the block level, as opposed to at the byte level, and further involve the operating system 104 in file data access (since the functions 118 and 120 are part of the operating system 104).

The close-file function 122 is called to close an opened or newly created file once data access to the file is finished. Like the initiate-file function 116, the close-file function 122 may have to be called regardless of whether a file has been accessed in a legacy block-oriented manner or in a direct byte-level DAX manner. In the MICROSOFT WINDOWS operating system, the close-file function 122 is CloseFile( ), whereas in the LINUX operating system, the close-file function 122 is close( ).

The operating system 104 exposes the functions 116, 118, 120, and 122 via respective APIs 124, 126, 128, and 130. Stated another way, the functions 116, 118, 120, and 122 have corresponding APIs 124, 126, 128, and 130 by which they can be called. Applications therefore access the functions 116, 118, 120, and 122 by respectively calling the APIs 124, 126, 128, and 130.

The DAX code 106 can include DAX memory mapping-creation code 132, DAX load code 134, DAX store code 136, and DAX memory mapping-removal code 138. Description of the code 132, 134, 136, and 138 is presented in example relation to a file 114 stored in a region 112 of the persistent memory 102 and an application program 110 and its application buffer 150. As noted above, the application buffer 150 is a part of the application memory space 111 that is allocated within volatile memory 113 when the application program 110 is executed.

The DAX memory mapping-creation code 132 creates a memory mapping 140 between the application memory space 111 of the application program 110 and the region 112 of persistent memory 102 storing the file 114. The memory mapping 140 permits subsequent direct byte-level DAX file access between the application program 110 and the memory region 112. The DAX memory mapping-creation code 132 may create the memory mapping 140 by using the CreateFileMapping( ) and MapViewofFile( ) functions in the MICROSOFT WINDOWS operating system, or the mmap( ) function in the LINUX operating system.

The DAX load code 134 copies requested file data from the memory region 112 to the application buffer 150. More specifically, the DAX load code 134 performs a load operation at the byte level directly from the memory region 112 to the application buffer 150, as mapped by the memory mapping 140. That is, the requested data of the file 114 is directly loaded from the memory region 112 of the persistent memory 102 to the application buffer 150.

The DAX store code 136 similarly copies file data placed in the application buffer 150 to the memory region 112. More specifically, the DAX store code 136 performs a store operation at the byte level directly from the application buffer 150 to the memory region 112, as mapped by the memory mapping 140. That is, the data intended for the file 114 and placed in the application buffer 150 is directly stored to the memory region 112 of the persistent memory 102.

The DAX memory mapping-removal code 138 removes or deletes the previously created memory mapping 140 between the application memory space 111 for the application program 110 and the region 112 of persistent memory 102 storing the file 114. The memory mapping 140 is removed when access to the file 114 stored in persistent memory 102 is finished. The DAX memory mapping-removal code 138 may remove the memory mapping 140 by using the UnmapViewOfFile( ) function in the MICROSOFT WINDOWS operating system, or the munmap( ) function in the LINUX operating system.

The interception code 108 intercepts calls 152, 154, 156, and 158 from the application program 110 to the functions 116, 118, 120, and 122 of the operating system 104 at their respective APIs 124, 126, 128, and 130, redirecting the calls 152, 154, 156, and 158 to the DAX code 132, 134, 136, and 138 instead. In the example implementation of FIG. 1, the interception code 108 adds hooks 142, 144, 146, and 148 to the APIs 124, 126, 128, and 130 to achieve call interception. By using such API hooking, the interception code 108 can therefore be said to inject the DAX code 132, 134, 136, and 138 to perform direct byte-level DAX file access in lieu of the legacy block-oriented file access afforded by the functions 116, 118, 120, and 122 of the operating system 104, which may not use DAX and which thus may be considered non-DAX file access functions.

An example of such code injection is known as dynamically loaded library (DLL) injection. A DLL is a library of program code that is loaded into memory at load or run time. The MICROSOFT WINDOWS operating system refers to DLLs as dynamically linked libraries. The LINUX operating system refers to DLLs as dynamically linked shared object libraries, dynamically linked shared objects, and/or dynamically linked share libraries. API hooking is thus one way by which the interception code 108 can achieve DLL injection to redirect calls to the APIs 124, 126, 128, and 130 of the functions 116, 118, 120, and 122 to the DAX code 132, 134, 136, and 138. Code injection other than DLL injection may also be employed, via API hooking or in another manner.

Another example of such code interception is known as a filter driver. Loading such a driver on top of the file system of the operating system, permits interception of calls from any application to the file system, such as calls to the initiate-file function 116, the read-file function 118, the write-file function 120, and the close-file function 122. The filter driver can thus redirect calls to the APIs 124, 126, 128, and 130 of the functions 116, 118, 120, and 122 to the DAX code 132, 134, 136, and 138, respectively.

In the specific case of the API 124 for the initiate-file function 116, the interception code 108 can add the hook 142 so that the DAX memory mapping-creation code 132 is performed in addition to the function 116 when the application program 110 calls the API 124. This is indicated in FIG. 1 by the solid line between the hook 142 and the API 124. The initiate-file function 116 may be performed first. Once the initiate-file function 116 has completed, the DAX memory mapping-creation code 132 is then performed.

By comparison, in the case of the API 126 for the read-file function 118, the interception code 108 can add the hook 144 so that the DAX load code 134 is performed in lieu of the function 118 when the application program 110 calls the API 126. This is indicated by the dotted line between the hook 144 and the API 126. As such, the read-file function 118 of the operating system 104 is not involved during file reads.

Similarly, in the case of the API 128 for the write-file function 120, the interception code 108 can add the hook 146 so that the DAX store code 136 is performed in lieu of the function 120 when the application program 110 calls the API 128. This is indicated in FIG. 1 by the dotted line between the hook 146 and the API 128. The write-file function 120 of the operating system 104 is therefore not involved during file writes.

As with the API 124 for the initiate-file function 116, in the case of the API 130 for the close-file function 122, the interception code 108 can add the hook 148 so that the DAX memory mapping-removal code 138 is performed in addition to the function 122 when the application program 110 calls the API 130. This is indicated in FIG. 1 by the solid line between the hook 148 and the API 130. The DAX memory mapping-removal code 138 may be performed first. Once the DAX memory mapping-removal code 138 has completed, it may then pass control to the close-file function 122. In another implementation, however, the close-file function 122 may be performed first, followed by the DAX memory mapping-removal code 138.

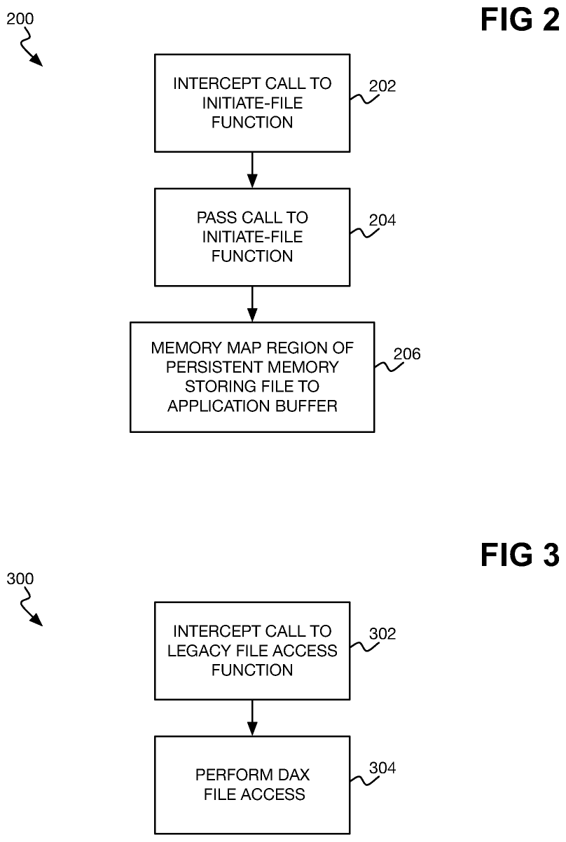

FIG. 2 shows an example method 200 for opening or creating the file 114 in the memory region 112 of the persistent memory 102 for subsequent DAX file access. The DAX code 106 and the interception code 108 can perform the method 200 in concert. As such, the method 200 can be implemented as program code (e.g., the code 106 and 108), which may be stored on a non-transitory computer-readable data storage medium and executable by a processor of a computing device.

The interception code 108 intercepts a call 152 with respect to the file 114 from the application program 110 to the API 124 of the initiate-file function 116 of the operating system 104 (202). For example, the call 152 may be an open-file call to an open-file function of the operating system 104 to open a file 114 that already exists, or a create-file call to a create-file function of the operating system 104 to create a new file 114. In the MICROSOFT WINDOWS operating system, the same CreateFile( ) function can be used as both the open-file function and the create-file function. In the LINUX operating system, the same open( ) function can be used as both the open-file function and the create-file function.

The interception code 108 may responsively pass the call 152 to (e.g., permit the call 152 to pass to) the initiate-file function 116 of the operating system 104 (204). Once the initiate-file function 116 has finished, the memory region 112 of the persistent memory 102 storing the opened or newly created file 114 is mapped to the application memory space 111 of the application program 110 (206). For instance, the interception code 108 may intercept the call 152 by adding the hook 142 so that the DAX memory mapping-creation code 132 of the DAX code 106 is performed after the initiate-file function 116 call has completed.

The DAX memory mapping creation code 132 may map the memory region 112 of the persistent memory 102 to the memory space 111 of the application program 110 by calling a create-mapping function of the operating system 104 to create the memory mapping 140 between the memory region 112 and the application memory space 111. The create-mapping function may be the CreateFileMapping( ) and MapViewofFile( ) functions in the MICROSOFT WINDOWS operating system, or the mmap( ) function in the LINUX operating system.

FIG. 3 shows an example method 300 for accessing data of the opened or newly created file 114 in the memory region 112 of the persistent memory 102 in a DAX manner. The method 300 can therefore be performed after the method 200 has been performed. The method 300 encompasses both file data reads and writes under the general rubric “file data access”; methods as to file data reads in particular and as to file data writes in particular are described later in the detailed description. The DAX code 106 and the interception code 108 can perform the method 300 in concert. Therefore, the method 300 can be implemented as program code stored on a non-transitory computer-readable data storage medium and executable by a processor of a computing device.

The interception code 108 intercepts a call with respect to data for the file 114 from the application program 110 to a legacy file access function of the operating system 104 (302), which may be a non-DAX file access function as noted above. The legacy file access function may be the read-file function 118 or the write-file function 120, for instance. In lieu of the legacy file access function being performed, the DAX code 106 instead responsively performs a direct load or store instruction with respect to the persistent memory region 112 storing the file 114 and the application buffer 150 of the application program 110.

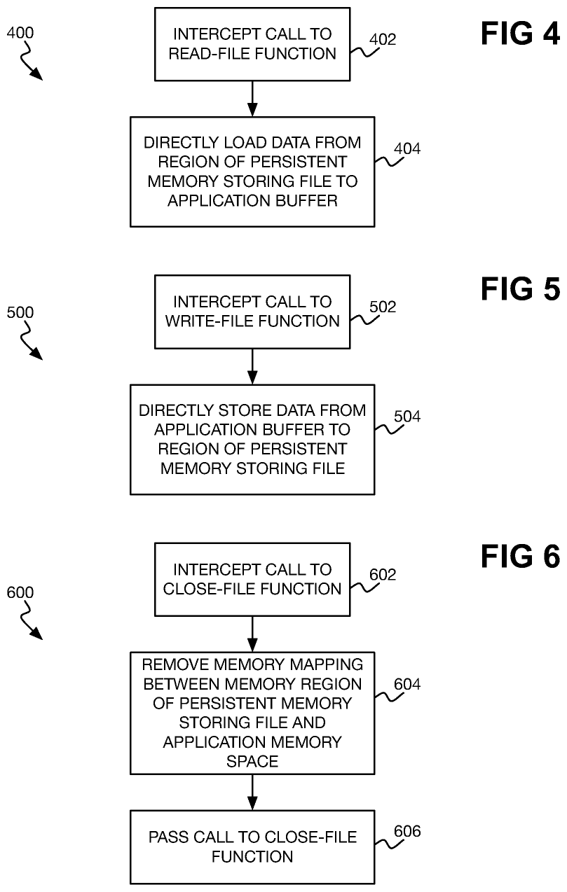

FIG. 4 shows an example method 400 for specifically reading data of the opened or newly created file 114 in the memory region 112 of the persistent memory 102 in a DAX manner. The method 400 can therefore be performed after the method 200 has been performed, and is an example implementation of the method 300 in the case of file data access that is a file data read. The DAX code 106 and the interception code 108 can perform the method 400 in concert. The method 400 can therefore be implemented as program code stored on a non-transitory computer-readable data storage medium and executable by a processor of a computing device.

The interception code 108 intercepts a call 154 with respect to data of the file 114 from the application program 110 to the API 126 of the legacy read-file function 118 of the operating system 104 (402), which may be a non-DAX file access function as noted above. For example, the call 154 may be a read-file call to read specified data from the file 114. As noted above, the read-file function 118 may be the ReadFile( ) function of the MICROSOFT WINDOWS operating system, or the read( ) function of the LINUX operating system.

The interception code 108 may instead direct the call 154 to the DAX load code 134 of the DAX code 106, which may responsively directly load the requested data of the file 114 from the persistent memory region 112 to the application buffer 150 of the application program 110 (404), using the previously created memory mapping 140. The interception code 108 may intercept the call 154 by adding the hook 144 so that the DAX load code 134 is performed in lieu of the read-file function 118. The application program 110 may reference the application buffer 150 within the read-file call 154.

FIG. 5 shows an example method 500 for specifically writing data to the opened or newly created file 114 in the memory region 112 of the persistent memory 102 in a DAX manner. The method 500 can therefore be performed after the method 200 has been performed, and is an example implementation of the method 300 in the case of file data access that is a file data write. The DAX code 106 and the interception code 108 can perform the method 500 in concert. The method 500 can therefore be implemented as program code stored on a non-transitory computer-readable data storage medium and executable by a processor of a computing device.

The interception code 108 intercepts a call 156 with respect to data of the file 114 from the application program 110 to the API 128 of the legacy write-file function 120 of the operating system 104 (502), which may be a non-DAX access file function as noted above. For example, the call 156 may be a write-file call to write specified data to the file 114. As noted above, the write-file function 120 may be the WriteFile( ) function of the MICROSOFT WINDOWS operating system, or the write( ) function of the LINUX operating system.

The interception code 108 may instead direct the call 156 to the DAX store code 136 of the DAX code 106, which may responsively directly store the specified data from the application buffer 150 of the application program 110 to the persistent memory region 112 (504), using the previously created memory mapping 140. The interception code 108 may intercept the call 156 by adding the hook 146 so that the DAX store code 136 is performed in lieu of the write-file function 120. The application program 110 may reference the application buffer 150 within the write-file call 156.

FIG. 6 shows an example method 600 for closing the file 114 in the memory region 112 of the persistent memory 102. The method 600 can therefore be performed after desired file access has occurred, such as pursuant to the method 300. The DAX code 106 and the interception code 108 can perform the method 600 in concert. The method 600 can be implemented as program code stored on a non-transitory computer-readable data storage medium and executable by a processor of a computing device.

The interception code 108 intercepts a call 158 to the API 130 of the close-file function 122 of the operating system 104 (602). For example, the call 158 may be a close-file call to the CloseFile( ) function in the MICROSOFT WINDOWS operating system, or to the close( ) function in the LINUX operating system. The interception code 108 may redirect the call 158 to the DAX memory mapping-removal code 138 of the DAX code 106. For example, the interception code 108 may intercept the call 158 so that the DAX memory mapping-removal code 138 is performed before the close-file function 122 in one implementation.

The DAX memory mapping-removal code 138 responsively removes the previously created memory mapping 140 between the persistent memory region 112 storing the file 114 and the application memory space 111 for the application program 110 (604). For instance, the DAX memory mapping-removal code 138 may call the UnmapViewOfFile( ) function in the MICROSOFT WINDOWS operating system, or the munmap( ) function in the LINUX operating system. Once the memory mapping 140 has been completed, the call 158 continues passage to the close-file function 122 of the operating system 104 (104), which closes the file 114.

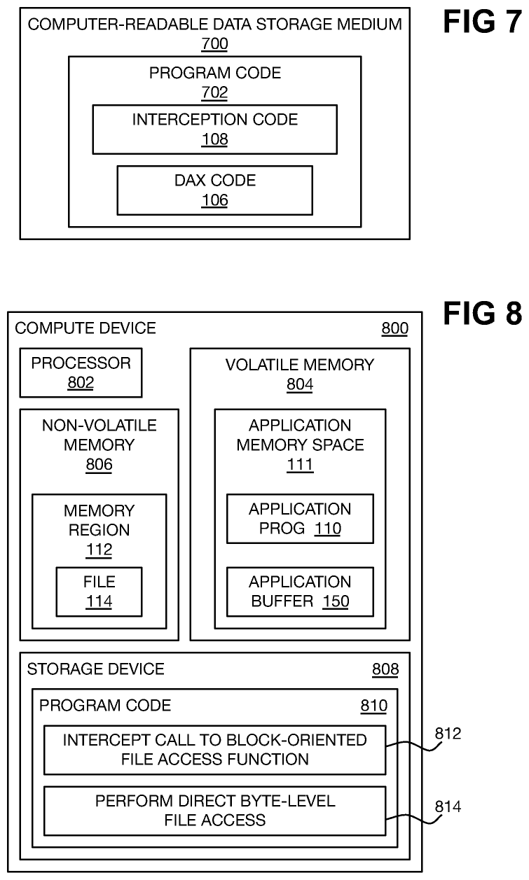

FIG. 7 shows an example non-transitory computer-readable data storage medium 700 storing program code 702 that is executable by a computing device. The program code 702 includes the interception code 108 and the DAX code 106. When executed, the interception code 702 causes the computing device to intercept a call with respect to data for a file 114 from an application program 110 running on the computing device to a legacy file access function of an operating system 104 running on the computing device. The legacy file access function may be the read-file function 118 or the write-file function 120.

When executed responsive to interception of the call, the DAX code 106 causes the computing device to perform DAX file access with respect to a memory region 112 of a persistent memory 102 storing the file 114 and an application buffer 150 for the application program 110 within the memory space 111 of volatile memory 109 to which the memory region 112 has been mapped. The DAX file access may be a load operation performed by the DAX load code 134 of the DAX code 106 when the file access is a file read. The DAX file access may be a store operation performed by the DAX store code 136 of the DAX code 106 when the file access is a file write.

FIG. 8 shows an example compute device 800, such as a computing device like a desktop or laptop computer, a server computing device, or another type of computing device. The compute device 800 includes a processor 802 and volatile memory 109, such as DRAM. The volatile memory 109 includes an application memory space 111 for an application program 110, including an application buffer 150 in relation to which DAX file access is performed, such as via load and store operations.

The compute device 800 includes byte-addressable non-volatile memory 806 and a storage device 808. The non-volatile memory 806 can be the persistent memory 102 that has been described, can include NVDIMMs, for instance, and provides byte-addressable persistent memory. By comparison, the storage device 808 may be a hard disk drive or a solid-state drive, which provides storage accessible in a block-oriented manner.

The storage device 808 stores program code 810 executable by the processor 802. For example, the program code 810 may include the DAX code 106 and the interception code 108. Upon loading of the program code 810 into volatile memory 109, execution of the code 810 causes the processor 802 to intercept a call with respect to data for the file 114 from the application program 110 to a block-oriented file access function of the operating system 104, such as the read-file function 118 or the write-file function 120 (812).

Execution of the program code 810 causes the processor 802 to responsively perform direct byte-level file access with respect to the memory region 112 and the application buffer 150 in lieu of the block-oriented file access function (814). For example, the direct byte-level file access may be a direct byte-level load operation performed by the DAX load code 134 of the DAX code 106 when the call is a read-file call. The direct byte-level file access may be a direct byte-level store operation performed by the DAX store code 136 of the DAX code 106 when the call is a read-file call.

Techniques have been described herein that permit applications that access files stored on persistent memory in a legacy block-oriented manner to instead access the files in a DAX manner at the byte level. The applications do not have to be updated or otherwise written to access such files in a DAX manner. File access calls from the applications to legacy block-oriented file-access functions of an operating system are instead intercepted and redirected to DAX file-access operations that perform file access directly at the byte level.

We claim:

1. A method comprising:
intercepting a call with respect to data for a file from an application program running on a computing device to a block-oriented file access function of an operating system running on the computing device; and
responsively performing direct access (DAX) file access with respect to a memory region of a persistent memory storing the file and an application buffer for the application program within an application memory space to which the memory region has been mapped.

2. The method of claim 1, wherein intercepting the call comprises intercepting a read-file call to read the data from the file, from the application program to a read-file function of the operating system,
and wherein performing the DAX file access comprises responsively directly loading the data from the memory region of the persistent memory storing the file to the application buffer for the application program.

3. The method of claim 1, wherein intercepting the call comprises intercepting a write-file call to write the data to the file, from the application program to a write-file function of the operating system,
and wherein performing the DAX file access comprises responsively directly storing the data from the application buffer for the application program to the memory region of the persistent memory storing the file.

4. The method of claim 1, wherein the call is a first call, and the method further comprises:
prior to intercepting the first call, intercepting a second call with respect to the file from the application program to an initiate-file function of the operating system;
responsively passing the second call to the initiate-file function of the operating system; and
after the initiate-file function of the operating system has completed, memory mapping the memory region of the persistent memory storing the file to the application memory space of the application program.

5. The method of claim 4, wherein intercepting the second call comprises intercepting an open-file call to open the file, from the application program to an open-file function of the operating system.

6. The method of claim 4, wherein intercepting the second call comprises intercepting a create-file call to create the file, from the application program to a create-file function of the operating system.

7. The method of claim 4, wherein memory mapping the memory region of the persistent memory storing the file to the application memory space for the application program comprises:
calling a create-mapping function of the operating system to create a memory mapping between the memory region of the persistent memory storing the file and the application memory space for the application program.

8. The method of claim 4, further comprising:
intercepting a close-file call to close the file, from the application program to a close-file function of the operating system; and
responsively removing the memory mapping between the memory region of the persistent memory storing the file and the application memory space for the application program; and
after removing the memory mapping, passing the close-file call to the close-file function of the operating system.

9. A non-transitory computer-readable data storage medium storing program code executable by a computing device, the program code comprising:
interception code to, when executed, cause the computing device to intercept a call with respect to data for a file from an application program running on the computing device to a legacy file access function of an operating system running on the computing device; and
direct access (DAX) code to, when executed responsive to interception of the call, cause the computing device to perform DAX file access with respect to a memory region of a persistent memory storing the file and an application buffer for the application program within an application memory space to which the memory region has been mapped.

10. The non-transitory computer-readable data storage medium of claim 9, wherein the DAX code comprises:
DAX load code to, when executed, cause the computing device to directly load the data from the memory region of the persistent memory storing the file to the application buffer for the application program; and
DAX store code to, when executed, cause the computing device to directly store the data from the application buffer for the application program to the memory region of the persistent memory storing the file.

11. The non-transitory computer-readable data storage medium of claim 10, wherein the interception code is to, when executed, cause the computing device to add:
a first hook to an application programming interface (API) for a legacy read-file function of the operating system to redirect read-file calls to the API for the legacy read-file function to the DAX load code instead; and
a second hook to an API for a legacy write-file function of the operating system to redirect write-file calls to the API for the legacy write-file function to the DAX store code instead.

12. The non-transitory computer-readable data storage medium of claim 9, wherein the DAX code comprises:
DAX memory mapping-creation code to, when executed, cause the computing device to create a memory mapping between the memory region of the persistent memory storing the file and the application memory space for the application program,
wherein the interception code is to, when executed, cause the computing device to add a hook to an application programming interface (API) for an initiate-file function of the operating system to call the DAX memory mapping code after the initiate-file function has completed.

13. The non-transitory computer-readable data storage medium of claim 12, wherein the hook is a first hook, and the DAX code further comprises:
DAX memory mapping-removal code to, when executed, cause the computing device to remove the memory mapping between the memory region of the persistent memory storing the file and the application memory space for the application program,
wherein the interception code is to, when executed, cause the computing device to add a second hook to an API for a close-file function of the operating system to call the DAX mapping code before the close-file function is called.

14. A compute device comprising:
a processor;
a volatile memory having an application memory space for an application program;
a non-volatile memory having a memory region to store a file, the memory region mapped to the memory space of the application program; and
a storage device storing program code executable by the processor to cause the processor to:
intercept a call with respect to data for the file from the application program to a block-oriented file access function of an operating system; and
responsively perform direct byte-level file access with respect to the memory region and an application buffer of the application memory space in lieu of the block-oriented file access function.

15. The compute device of claim 14, wherein the processor is to intercept the call and responsively perform the direct byte-level function by application programming interface (API) hooking to intercept the call to perform the direct byte-level file access in lieu of the block-oriented file access function.
